(19) United States
(12) Patent Application Publication
(10) Pub. No.: US 2012/0229077 A1
(43) Pub. Date: Sep. 13, 2012

(54) ELECTRIC POWER SUPPLY SYSTEM AND METHOD FOR CONTROLLING ELECTRIC POWER DISCHARGE

(75) Inventor: Shizuo Tsuchiya, Gifu-city (JP)

(73) Assignee: DENSO CORPORATION, Kariya-city (JP)

(21) Appl. No.: 13/412,981

(22) Filed: Mar. 6, 2012

(30) Foreign Application Priority Data
Mar. 7, 2011 (JP) 2011-049231

(51) Int. Cl. H02J 7/00

(52) U.S. Cl. 320/107; 320/135

(57) ABSTRACT

An electric power accumulating device is charged with electric power supplied from an electric power system and is configured to discharge electric power to a load device. A control unit predicts, with reference to an electric power consumption result of the load device, an electric power consumption of the load device in each time zone in one day and determines, according to the predicted electric power consumption, a discharge implementation time zone or a discharge threshold. The control unit causes the electric power accumulating device to discharge electric power to the load device when determining that the present time is in the discharge implementation time zone or when an electric power consumed by the load device is greater than or equal to the determined discharge threshold.

### CROSS REFERENCE TO RELATED APPLICATION

This application is based on Japanese Patent Application No. 2011-49231 filed on Mar. 7, 2011, the disclosure of which is incorporated herein by reference.

### TECHNICAL FIELD

The present disclosure relates to an electric power supply system configured to control electric power discharged from an electric power accumulating device to supply electric power to an electric device in a building. The present disclosure further relates to a method for controlling electric power discharge from the electric power accumulating device.

### BACKGROUND

JP-A-2003-143763 discloses an electric power system. The electric power supply system of JP-A-2003-143763 is configured, in cooperation with an electric power distribution system of an electric power company, to cause entire battery equipment commonly used in all houses to function as an electric power storage unit and to supply electric power to load devices in multiple residences. The electric power supply system of JP-A-2003-143763 causes the storage battery to discharge electric power through an electric power conditioner provided in each residence only when electric power consumed by the load devices in each residence exceeds a certain value.

It is noted that, the electric power supply system of JP-A-2003-143763 is configured to cause the storage battery to discharge electric power to the load devices in each residence only when electric power consumed by the load devices exceeds the certain value. With the present configuration, the electric power supply system starts and stops electric power discharge, irrespective of the capacity of the storage battery and actual condition of electric consumption by a user. Thus, the configuration of JP-A-2003-143763 may not be configured sufficiently to utilize electric power stored in the storage battery effectively.

### SUMMARY

It is an object to provide an electric power supply system configured to cause an electric power accumulating device to discharge electric power to a load device in conformity to actual electric consumption. It is another object to provide a method for controlling electric power discharge from the electric power accumulating device.

According to an aspect of the present disclosure, an electric power supply system comprises an electric power accumulating device configured to be charged with electric power, which is supplied from an electric power system into a building under a contract, and configured to discharge electric power to a load device of the building. The electric power supply system further comprises a control device configured to store an electric power consumption result of the load device, rewrite a previous electric power consumption result to update the electric power consumption result as learning information, and control electric power discharge from the electric power accumulating device to the load device with reference to the learning information. The control unit is further configured to predict, with reference to the learning information, an electric power consumption consumed by the load device in each time zone in one day, determine, according to the predicted electric power consumption in each time zone in one day, a discharge implementation time zone or a discharge threshold, and implement electric power discharge from the electric power accumulating device to the load device, when determining that present time is in the discharge implementation time zone in one day, or when a load electric power consumed by the load device is greater than or equal to the determined discharge threshold.

According to another aspect of the present disclosure, a method for controlling electric power discharge from an electric power accumulating device, the electric power accumulating device being configured to be charged with electric power, which is supplied from an electric power system into a building under a contract, and configured to discharge electric power to a load device of the building, the method comprises predicting an electric power consumption consumed by the load device in each time zone in one day, with reference to an electric power consumption result of the load device being stored and updated. The method further comprises determining, according to the predicted electric power consumption, a discharge implementation time zone or a discharge threshold. The method further comprises causing the electric power accumulating device to discharge electric power to the load device, when determining that present time is in the discharge implementation time zone, or when a load electric power consumed by the load device is greater than or equal to the determined discharge threshold.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an overview showing an electric power supply system according to a first embodiment;

FIG. 2 is a block diagram showing a configuration of a control to cause a storage battery in the electric power supply system to discharge electric power;

FIG. 3 is a flow chart showing an example of operation of the electric power supply system in one day;

FIG. 4 is a flowchart showing an electric power discharge control processing of the storage battery, according to the first embodiment;

FIG. 5 is a flowchart showing an electric power discharge control processing of the storage battery, according to the second embodiment;

FIG. 6 is a flowchart showing an electric power discharge control processing of the storage battery, according to the third embodiment; and

FIG. 7 is a flowchart showing an electric power discharge control processing of the storage battery, according to the fourth embodiment.

### DETAILED DESCRIPTION

As follows, embodiments will be described with reference to drawings. In the embodiments, an element described in a subsequent embodiment may be denoted by the same reference numeral, and description of such an element may be omitted. When only a part of a structure of an element is described in an embodiment, other part of the structure of the element may be equivalent to that of another foregoing embodiment. Combinations of elements are not limited to those specified in an embodiment. As long as a combination does not cause a defect, various combinations of elements and embodiments may be arbitrary made.

### First Embodiment

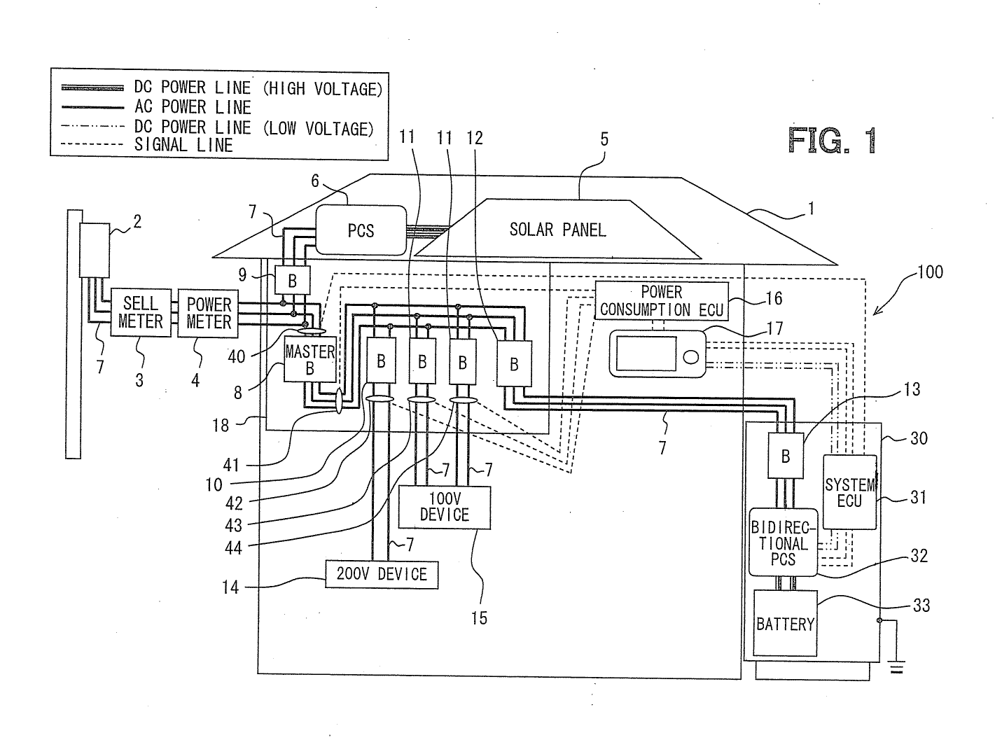

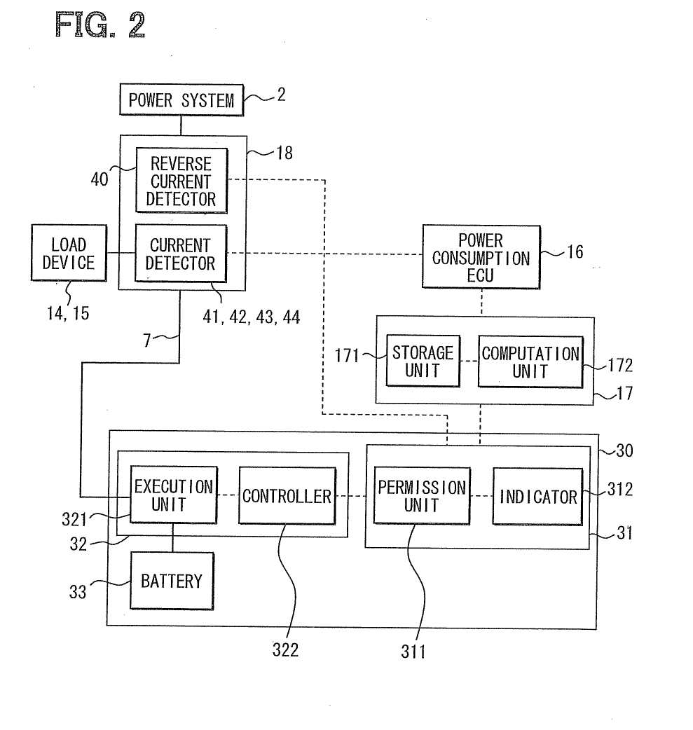

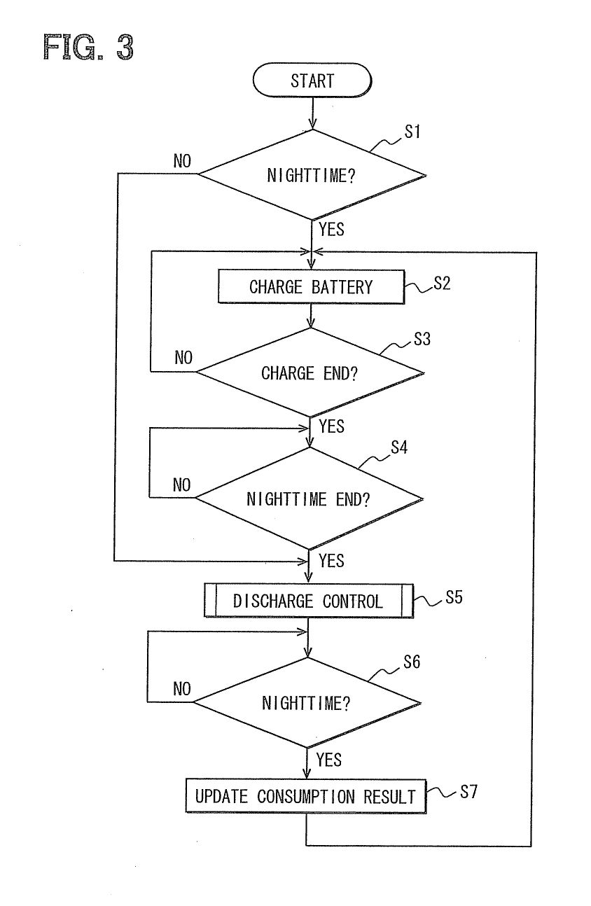

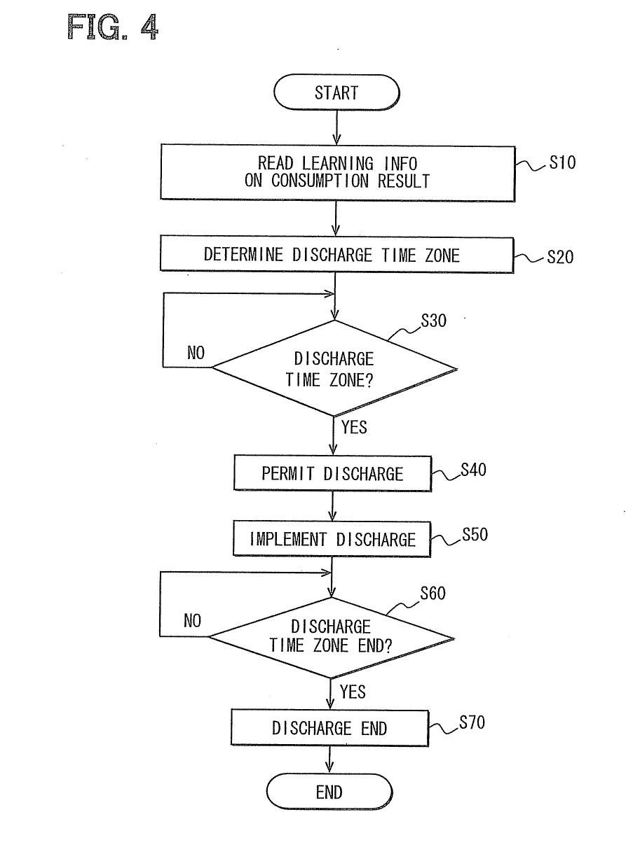

The first embodiment will be described with reference to FIG. 1, FIG. 2, FIG. 3, and FIG. 4. FIG. 1 is a schematic view showing an electric power supply system 100 according to the first embodiment. FIG. 2 is a block diagram showing a configuration of a control to cause a storage battery 33 in the electric power supply system 100 to discharge electric power.

The electric power supply system 100 is configured to charge the storage battery 33 with electric power supplied from an electric power system 2 of an electric power supply source (electric power company) to a building 1, under an electric power supply contract. The electric power supply system 100 is further configured to supply electric power from the electric power system 2 to load devices of the building 1. The load devices include a 200V device 14, a 100V device 15, and/or the like. The electric power supply system 100 is further configured to discharge electric power stored in the storage battery 33 to the load devices. The electric power supply system 100 further includes a solar power generation device as one example of exploitation of natural energy (reusable energy). With the present configuration, the electric power supply system 100 is configured to supply electric power generated with the solar power generation device to the load devices and to charge the storage battery 33 with the generated electric power.

The electric power supply system 100 is configured to charge the storage battery 33 with electric power in a specific time zone in which electricity bill is cheaper than that in other time zones, under the electric power supply contract. The specific time zone is, for example, a late-night charge time zone from 23:00 to 7:00 in which a late-night charge system is applied. The electric power supply system 100 controls discharge of electric power stored in the storage battery 33 and accumulated in the late-night charge time zone applied with the late-night charge system. In addition, the electric power supply system 100 prioritizes use up of electric power stored in the storage battery 33 for operation of the load devices rather than sales of electric power to the electric power supply source. The present operation is adopted, since use of electric power for operation of the load devices in daytime can promote effective use of electric power steadily, and in consideration that electric power soled to the electric power supply source may not be used effectively.

The electric power supply system 100 has a function to store an electric power consumption result of the load devices and to rewrite a stored previous electric power consumption result with a new electric power consumption result thereby to learn the new electric power consumption result. The electric power supply system 100 controls electric power discharge from the storage battery 33 to the load devices by utilizing learning information being continually updated, thereby to implement an electric power discharge control suited for a user's actual electric power consumption result.

It is assumed a condition where accumulation of electric power in the storage battery 33 is not sufficient for supplying electric power to be consumed in daytime. In such a condition, the electric power supply system 100 compensates the deficiency with electric power generated with the solar power generation device when the solar power generation device generates electric power sufficiently to compensate the deficiency. Alternatively, the electric power supply system 100 compensates the deficiency with electric power supplied from the electric power system 2 when the solar power generation device does not generate electric power or when the solar power generation device generates electric power insufficiently. When the solar power generation device generates surplus electric power, the electric power supply system 100 may sell the surplus electric power to the electric power supply source or may store the surplus electric power in the storage battery 33.

Referring to FIG. 1, the electric power supply system 100 includes, for example, an alternating-current electric power line 7, load devices, an electric power storage unit 30, an operation panel 17, and a solar power generation device. The alternating-current electric power line 7 is wired in the building 1, which is, for example, a residence. The load devices are electrically connected to the alternating-current electric power line 7. The electric power storage unit 30 is electrically connected to the alternating-current electric power line 7. The operation panel 17 is connected to the electric power storage unit 30 through a direct-current electric power line. The solar power generation device generates electric power with sunlight. The alternating-current electric power line 7 introduces purchased electric power supplied from the electric power system 2 of the electric power company into the building 1. The alternating-current electric power line 7 is connected with a power-selling meter 3 and an electric power meter 4. The power-selling meter 3 measures sales of electric power. The electric power meter 4 measures introduction of electric power.

The alternating-current electric power line 7 wired in the building 1 is, for example, a single-phase three-wire power source wire including one neutral wire and two voltage lines. Electric power (grid power) introduced from the electric power system 2 of the electric power company is distributed in a distribution board 18 and supplied through the alternating-current electric power line 7. The distribution board 18 includes a master breaker 8 and breakers 9, 10, 11, 12. The master breaker 8 regulates an upper limit of an electric current flowing into each circuit system. The breaker 9 is for the solar power generation device. The breaker 10 is for the 200V load device. The breaker 11 is for the 100V load device. The breaker 12 is for the electric power storage unit 30. The alternating-current electric power line 7 is equipped with the breaker 12. The alternating-current electric power line 7 is further equipped with a breaker 13 located in the electric power storage unit 30 and used for the electric power storage unit 30. The alternating-current electric power line 7 is branched in the distribution board 18 into a solar electric power conditioner (solar electric power PCS) 6, a bidirectional power conditioner (bidirectional PCS) 32, the 200V device 14, and the 100V device 15.

The master breaker 8 is a single-phase three-wire 200V-type short circuit detection breaker having a neutral-wire open-phase protection function. When open phase occurs in the neutral wire due to a certain reason, the voltage between the voltage line of the light-load side and the neutral wire increases possibly to apply high-voltage to a light-load side device. In consideration of this, the neutral-wire open-phase protection function is for automatically terminating the circuit when open phase occurs in the neutral wire thereby to regulate voltage applied to the light-load side device. The breaker 9 for the solar power generation device is a single-phase three-wire 200V-type short circuit detection breaker having a neutral-wire open-phase protection function and being adapted to reverse connection. The breaker 10 is a single-phase two-wire 200V-type short circuit detection breaker for regulating the maximum amount of an electric current supplied to the 200V device 14, such as an IH appliance and an airconditioner, in the building 1. The breaker 11 is a single-phase two-wire 100V-type short circuit detection breaker for regulating the maximum amount of an electric current supplied to the 100V device 15, such as an electric and electronic devices supplied with 100V, in the building 1. Each of the breaker 12 and the breaker 13 is a single-phase three-wire 200V-type short circuit detection breaker having a neutral-wire open-phase protection function and being adapted to reverse connection. The breaker 12 and the breaker 13 are for regulating the maximum amount of an electric current supplied to the electric power storage unit 30.

A reverse current detector 40 is provided to the power source wire on the upstream side of the master breaker 8 for detecting a reverse power flow electric current. An electric current detector 41 is provided to the power source wire on the downstream side of the master breaker 8 for detecting the summation of an electric current supplied to the load devices and an electric current supplied to the storage battery 33. An electric current detector 42 is provided to the power source wire on the downstream side of the breaker 10 for detecting an electric current supplied to the 200V device 14 among the load devices. Electric current detectors 43, 44 are provided to the power source wires on the downstream side of the breakers 11 for detecting an electric current supplied to the 100V device 15 among the load devices. The electric current detected with each of the electric current detectors 41, 42, 43, and 44 is inputted into the electric power consumption computation ECU 16. The electric current detected with the reverse current detector 40 is inputted into a system ECU 31. The electric power consumption computation ECU 16 is a control device configured to calculate electric consumption caused by the load devices and the like on the side of the building 1, according to the electric current detected with each of the electric current detectors 41, 42, 43, and 44 and the like.

The solar power generation device supplies electric power, which is generated with sunlight, as external power into the alternating-current electric power line 7. The electric power generated with sunlight is one example of a natural power source (reusable energy). The solar power generation device includes a solar energy generator panel 5 and a solar electric power PCS 6. The solar energy generator panel 5 is equipped on the roof of the building 1. The solar electric power PCS 6 is supplied with the sunlight electric power generated by the solar energy generator panel 5. The solar electric power PCS 6 is electrically connected to the alternating-current electric power line 7. The solar electric power PCS 6 converts direct-current electricity supplied from the solar energy generator panel 5 into alternating-current electricity and discharges the converted alternating-current electricity into the alternating-current electric power line 7. The solar electric power PCS 6 is communicable with various kinds of control devices.

The alternating-current electric power line 7 is connected with the electric power storage unit 30 (power storage system, e-Station). The electric power storage unit 30 is, for example, located outside the building 1. The electric power storage unit 30 includes the bidirectional PCS 32, the storage battery 33, the system ECU 31, and the like. The storage battery 33 is, for example, an aggregate of combined multiple unit batteries each being a rechargeable battery such as a lithium ion battery.

The bidirectional PCS 32 includes, for example, a charge-discharge and PCS control board, a power converter circuit, a communication board, and the like. The storage battery 33 is electrically connected with the alternating-current electric power line 7 through the bidirectional PCS 32. The storage battery 33 is configured to be charged with the alternating-current electric power supplied through the alternating-current electric power line 7 and to discharge direct-current electric power stored in the storage battery 33 into the alternating-current electric power line 7.

The system ECU 31 is a control device for managing a charge-and-discharge control of the storage battery 33 in the electric power supply system 100. The system ECU 31 is communicably connected with the bidirectional PCS 32 and configured to implement communications in compliance with a telecommunications standard such as RS-485 to control the operation of the bidirectional PCS 32 and the operation of the storage battery 33. The storage battery 33 is equipped with a storage battery monitor ECU. The system ECU 31 is further connected communicably with the storage battery monitor ECU through the bidirectional PCS 32. The operation panel 17 has an indication screen configured to be operated by a used and to provide information to be confirmed by a user. The system ECU 31 is connected with the operation panel 17 through the direct-current electric power line at a low voltage and communicable with the operation panel 17 to control the indication screen on the operation panel 17. The system ECU 31 is communicable with various devices, such as the various control devices, the various detectors, and the like, in connection with the electric power supply system 100 in this way. With the present configuration, the system ECU 31 is configured to exchange various information bilaterally with the various devices thereby to control operations of the various devices.

The operation panel 17 is a remote controller provided in, for example, the building 1 to enable remote operation. The operation panel 17 is communicably connected with the electric power consumption computation ECU 16. As shown in FIG. 2, the operation panel 17 includes, for example, a storage unit 171 and a computation unit 172. The storage unit 171 inputs electric power consumed by the load devices, as an electric power consumption result, from the electric power consumption computation ECU 16 and stores the electric power consumption result. The storage unit 171 rewrites a previous electric power consumption result with the stored electric power consumption result thereby to update the electric power consumption result as learning information. The updated learning information is used when electric power is discharged from the storage battery 33 to the load devices. Specifically, the updated learning information is used when the computation unit 172 determines an electric power discharge implementation time zone based on an electric power discharge threshold used as a reference to determine whether to implement the electric power discharge.

The system ECU 31 includes a charge-and-discharge permission unit 311 and an electric power instruction unit 312. The charge-and-discharge permission unit 311 implements computation by executing a predetermined control program and an updatable control program with reference to the computation result of the computation unit 172 thereby to determine charge permission or discharge permission. On determination of the charge permission, the charge-and-discharge permission unit 311 instructs the charge permission to a charge-and-discharge execution unit 321 of the bidirectional PCS 32. On determination of the discharge permission, the charge-and-discharge permission unit 311 implements computation by executing the control programs shown in FIGS. 3 and 4 (described later) with reference to the electric power discharge implementation time zone determined by the computation unit 172 thereby to determine whether to instruct electric power discharge. When the charge-and-discharge permission unit 311 determines charge permission or discharge permission, the electric power instruction unit 312 transmits charge electric power or discharge electric power to a power regulation unit 322 of the bidirectional PCS 32 to instruct the charge electric power or discharge electric power.

The power regulation unit 322 of the bidirectional PCS 32 implements electric power control according to the instruction transmitted from the electric power instruction unit 312. The charge-and-discharge execution unit 321 of the bidirectional PCS 32 implements charge electric power control or discharge electric power control according to the electric power controlled by the power regulation unit 322. The power regulation unit 322 or the charge-and-discharge execution unit 321 may be configured with the power converter circuit and the charge-discharge and PCS control board.

In the state where electric power is discharged from the storage battery 33 to the alternating-current electric power line 7, and on detection of reverse power flow from the alternating-current electric power line 7 into the electric power system 2 according to the input signal from the reverse current detector 40, the system ECU 31 controls the charge-discharge and PCS control board to prohibit electric power discharge. A direct-current electric power line is extended from the DC-DC converter of the bidirectional PCS 32 through the system ECU 31 to the operation panel 17. The present configuration enables activation of the system ECU 31 and the operation panel 17 when grid power (electric power introduction) from the electric power system 2 fails.

As follows, an example of operation of the electric power supply system 100 will be described with reference to FIGS. 3 and 4. FIG. 3 is a flow chart showing an example of operation of the electric power supply system in one day. FIG. 4 is a flowchart showing an electric power discharge control processing of the storage battery in FIG. 3. The system ECU 31 functions as a main control unit to control the following operation

As shown in FIG. 3, when the electric power supply system 100 is activated, at step S1, the system ECU 31 first determines whether the present time is in a late-night charge time zone. The late-night charge time zone is, for example, a time zone from 23:00 to 7:00 in the next morning. When the present time is out of the late-night charge time zone, the storage battery 33 cannot be charged with late-night electric power, since the present time is in a daytime zone other than the late-night charge time zone. Therefore, in this case, the processing proceeds to a “charge-and-discharge control processing of the storage battery” at step S5 (described later).

Alternatively, when the system ECU 31 determines that that the present time is in the late-night charge time zone at step S1, the system ECU 31 implements a “charge step for the storage battery” to charge the storage battery 33 with late-night electric power (step S2). In the charge step for the storage battery, the system ECU 31 calculates electric power to be supplied from the storage battery 33, according to the learning information related to the electric power consumption result of the load devices stored in the storage unit 171. The charge of the storage battery 33 is repeatedly implemented until the system ECU 31 determines that accumulation of electric power in the storage battery 33 increases to the electric power in the late-night charge time zone at step S3. The electric power is, for example, an insufficiency between a predicted power generation, by which the solar power generation device is predicted to generate electric power until the next day, and prediction of electric power consumed by the loads obtained with reference to the learning information. The predicted power generation can be calculated according to, for example, a previous power generation result and prediction of weather in the next day. The system ECU 31 implements reverse calculation of an electric current to be supplied into the storage battery 33, such that the storage battery 33 can be charged with electric power sufficiently by the end of the late-night charge time zone. The system ECU 31 further controls the grid power to supply the calculated electric current, thereby to implement the charge control of the storage battery.

On determination at step S3 that the charge of the storage battery 33 is completed, the system ECU 31 waits until the system ECU 31 determines at step S4 that the late-night charge time zone ends. On determination at step S4 that the late-night charge time zone ends, the system ECU 31 implements at step S5 the “electric power discharge control processing of the storage battery,” since the present time transits into, for example, a time zone subsequent to 7:00 in the next morning, other than the late-night charge time zone. The “electric power discharge control processing of the storage battery” relates to electric power discharge from the storage battery 33 to the load devices.

Subsequently, the “electric power discharge control processing of the storage battery” at step S5 will be described with reference to FIG. 4. At step S10, the system ECU 31 first implements a processing to read learning information relating to the electric power consumption result of the load devices stored in the storage unit 171, and the processing proceeds to step S20. The previous electric power consumption result is a previous result in predetermined days such as 14 days. For example, in a case where there are two kinds of a result in a weekday and a result in a holiday (Saturday and Sunday), the learning information related to one of the two kinds of results is selected according to the day when the learning information is read.

At step S20, the system ECU 31 determines a distribution of predicted electric power consumption for each time zone in the present day (today) according to the learning information being read. The system ECU 31 determines a discharge threshold for determining whether to implement electric power discharge in each time zone in the distribution of the predicted electric power consumption. In the present determination, the system ECU 31 has a determination criterion to secure the electric power discharge efficiency of the storage battery 33 to be higher than or equal to a predetermined efficiency and to use up accumulation of electric power in the storage battery 33 effectively. The system ECU 31 further determines a time zone, in which the predicted electric power consumption is greater than the discharge threshold, as a discharge implementation time zone in the predicted electric power consumption distribution. The electric power discharge efficiency of the storage battery 33 is low when electric power consumption occurring in a power device to cause the storage battery 33 to discharge electric power is large, relative to discharge of electric power from the storage battery 33. For example, when the storage battery 33 discharges electric power, the electric power discharge efficiency of the storage battery 33 is low when the rate of energy loss, which is caused by electric power consumption in a circuit board and the like, relative to discharge of electric power, which is from the storage battery 33, is large. Alternatively, the electric power discharge efficiency of the storage battery 33 is high when the rate is small.

Thus, the discharge threshold is determined such that the determination criterion is satisfied by implementing electric power discharge from the storage battery 33 when the predicted electric power consumption calculated according to the learning information is greater than or equal to the discharge threshold. In addition, the discharge threshold is determined such that the determination criterion is satisfied by not implementing electric power discharge from the storage battery 33 when the predicted electric power consumption calculated according to the learning information is less than the discharge threshold.

In addition, the distribution of the predicted electric power consumption among the time zones in one day is not constant and may have a large fluctuation range. For example, in a case of a four-member family including two children, the predicted electric power consumption consumed by the load devices may temporarily increase in early morning before going to school or going to work. Nevertheless, the time period, in which the predicted electric power consumption becomes great, is short in morning. Since the number of the members of the family in the building 1 decreases after a part of the members of the family goes to school or goes to work, the predicted electric power consumption quickly decreases, and the fluctuation of the predicted electric power consumption also decreases. The present tendency continues until about 3:00 p.m. Thereafter, for example, the children come back home to start operation of electric appliances (load devices), and consumption of hot water also increases for preparation of supper and bath to result in increase in electric power consumption, in the evening from about 5:00 p.m. The present state in the evening continues relatively long.

In such a case, the predicted electric power consumption is small in the time zones between the morning and the evening. Therefore, it is not preferable to cause the storage battery 33 to discharge electric power in the time zones from a viewpoint of the determination criterion. In such time zones, it is more preferable to supply electric power generated with the solar power generation device and to supply grid power from the electric power system 2 to the load devices, rather than causing the storage battery 33 to discharge electric power. To the contrary, the predicted electric power consumption increases in time zones after the evening. Therefore, it is preferable to cause the storage battery 33 to discharge electric power in such time zones, from a viewpoint of effective and efficient use of electric power. The present determination of the discharge implementation time zone and the control of the electric power discharge from the storage battery in such time zones contribute to implement the electric power discharge control conforming to actual user's electric power consumption result. In addition, the present determination and the control further enable energy use effective to reduce environmental burden and to improve user's application with adroit use of grid power and natural power source (reusable energy).

At subsequent step S30, the system ECU 31 determines whether the present time transits into the determined discharge implementation time zone. When the system ECU 31 determines that the present time transits into the determined discharge implementation time zone, the processing proceeds to step S40 at which the charge-and-discharge permission unit 311 instructs discharge permission to the charge-and-discharge execution unit 321. At step S50, the charge-and-discharge execution unit 321 implements electric power discharge from the storage battery 33.

The electric power discharge from the storage battery 33 is continued until the system ECU 31 determines that the discharge implementation time zone ends at step S60. When the system ECU 31 determines that the discharge implementation time zone ends at step S60, the processing proceeds to step S70. At step S70, the system ECU 31 terminates the electric power discharge from the storage battery 33 and terminates the “electric power discharge control processing of the storage battery.”

On termination of the “electric power discharge control processing of the storage battery,” the processing proceeds to step S6. At step S6, the system ECU 31 determines whether the present time is in the late-night charge time zone. When the present time transits into the late-night charge time zone, the processing proceeds to step S7. At step S7, the system ECU 31 causes the storage unit 171 to store the electric power discharge result of the storage battery 33 in time zones other than the today's late-night charge time zone thereby to update the electric power consumption result of the load device. Subsequently, the processing proceeds to step S2, and the subsequent steps are implemented continuously.

As follows, the operation effect of the electric power supply system 100 according to the present embodiment will be described. The electric power supply system 100 stores the electric power consumption result of the load devices and rewrites the previous electric power consumption result with the present electric power consumption result thereby to update the electric power consumption result as learning information. The electric power supply system 100 further controls electric power discharge from the storage battery 33 to the load devices with reference to the learning information. The electric power supply system 100 calculates the predicted electric power consumption of the load devices for each time zone in one day with reference to the learning information obtained from the electric power consumption result. The electric power supply system 100 further determines the discharge implementation time zone, in which electric power discharge is implemented from the storage battery 33 to the load devices, with reference to the predicted electric power consumption in the each time zone. The electric power supply system 100 implements electric power discharge from the storage battery 33 when the present time is in the determined discharge implementation time zone in one day.

With the present configuration of the control and calculation, the predicted electric power consumption of the load devices is calculated for each time zone with reference to the learning information obtained from the electric power consumption result. Therefore, the predicted electric power consumption reflects actual use condition by a user. The discharge implementation time zone functions as a trigger for implementing the electric power discharge from the storage battery 33 to the load devices. With the present configuration, the discharge implementation time zone is determined according to the predicted electric power consumption reflecting, i.e., suitable for the actual use condition. Thus, the electric power discharge control according to the present embodiment is adaptive to each user. Thus, with the present configuration, the electric power supply system 100 is enabled to cause the storage battery 33 to discharge electric power to the load devices suitably for an actual condition of electric consumption by a user and to promote effective use of energy.

It is noted that, when electric power discharge of the storage battery 33 is implemented, a related device such as a circuit board consumes certain electric power. Therefore, when the load devices do not consume a large amount of electric power, electric power consumed in the circuit board becomes large relative to electric power supplied from the storage battery 33 when electric power discharge is implemented. In such a case, efficiency of electric power discharge from the storage battery 33 decreases, and it is not preferable in view of effective use of energy. In the present embodiment, the discharge implementation time zone is determined with the determination criterion to secure the electric power discharge efficiency of the storage battery 33 higher than or equal to the predetermined efficiency and to use up accumulation of electric power in the storage battery 33 effectively. Therefore, the configuration of the present embodiment enables desirable electric power discharge control in view of effective energy use.

### Second Embodiment

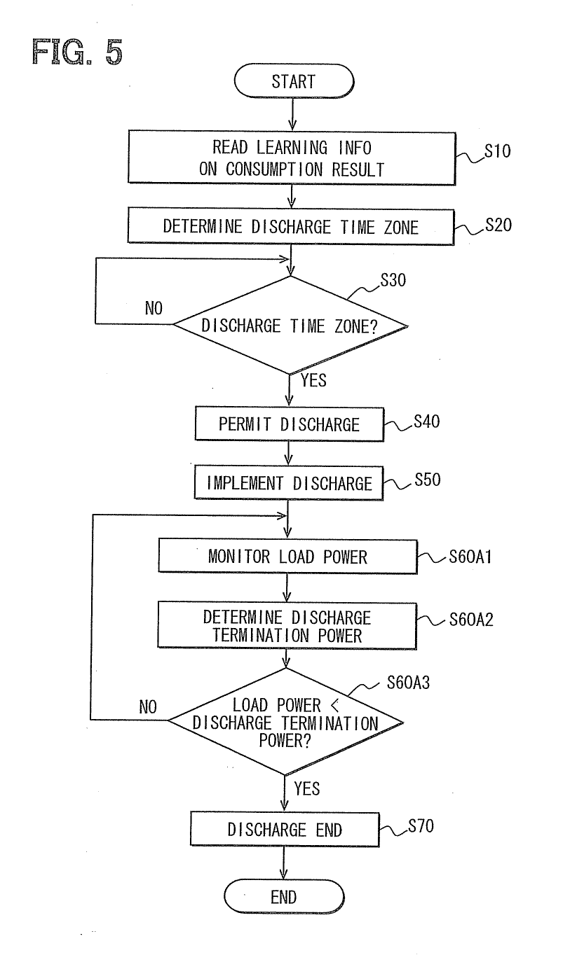

In the second embodiment, another example of the “electric power discharge control processing of the storage battery” in the first embodiment will be described with reference to FIG. 5. FIG. 5 is a flowchart showing the electric power discharge control processing of the storage battery, according to the second embodiment. The configuration, the operation, the control, the processing denoted by the same step reference numeral, etc. without specific notation in the present embodiment are deemed to be equivalent to those in the first embodiment and are deemed to produce an equivalent operation effect.

The “electric power discharge control processing of the storage battery” according to the present embodiment shown in FIG. 5 is different in step S60A1, step S60A2, and step S60A3 from the processing of FIG. 4 of the first embodiment.

As follows, the control different from that of the first embodiment will be described. As shown in FIG. 5, according to the processing of the second embodiment, the condition to terminate electric power discharge is determined according to actual electric power supplied to the load devices, subsequent to the “electric power discharge implementation of the storage battery” at step S50. Further, the electric power discharge of the storage battery is terminated on determination that a predetermined end condition of the electric power discharge is satisfied.

Subsequent to the “electric power discharge implementation of the storage battery” at step S50, the processing proceeds to step S60A1. At step S60A1, actual electric power (actual load electric power) demanded by the load devices is detected and monitored. Specifically, the actual load electric power is electric power actually demanded by the load devices, such as the 200V device 14 and the 100V device 15, during electric power discharge from the storage battery 33. The actual load electric power may deviate from the predicted electric power consumption distribution in time zones determined with reference to the learning information. The deviation may occur, for example, in a case where the actual load electric power shows a large fluctuation when the actual load electric power is smaller than a predicted value and/or when the actual load electric power temporarily increases or decreases.

The electric power discharge can be controlled suitably in response to the present condition by monitoring the actual load electric power when a large deviation occurs between the actual consumption of electric power and the predicted value. At step S60A2, the system ECU 31 determines a discharge termination value being a condition to terminate the electric power discharge, according to the actual load electric power being monitored. The discharge termination value is a threshold used when the system ECU 31 terminates the electric power discharge of the storage battery 33, in view of the electric power discharge efficiency, in a condition where the actual load electric power decreases to be less than the discharge termination value.

At step S60A3, the system ECU 31 determines whether the actual load electric power decreases to be less than the discharge termination value during the electric power discharge. The system ECU 31 continues the electric power discharge from the storage battery 33 until determining that the actual load electric power decreases to be less than the discharge termination value at step S60A3. On determination that the actual load electric power decreases to be less than the discharge termination value at step S60A3, the system ECU 31 terminates the electric power discharge from the storage battery 33 at step S70 and terminates the “electric power discharge control processing of the storage battery.”

As follows, an operation effect of the electric power supply system 100 according to the present embodiment will be described. The electric power supply system 100 detects the actual load electric power demanded by the load devices and retrieves fluctuation in the load electric power when implementing the electric power discharge from the storage battery 33 to the load devices (step S60A1). The system ECU 31 further determines the discharge termination value, at which the system ECU 31 terminates the electric power discharge from the storage battery 33, according to the fluctuation in the retrieved load electric power (step S60A2). The system ECU 31 terminates the electric power discharge from the storage battery 33 when the load electric power supplied to the load devices decreases to be lower than the discharge termination value (step S60A2).

With the present control, the condition for termination of the electric power discharge can be set, after starting the electric power discharge from the storage battery, according to the actual load electric power consumed by the load devices. By setting the condition for termination of the electric power discharge in this way, proper utilization of energy can be implemented adaptively to the actual condition, in a case where actual electric consumption is different from the predicted electric consumption obtained from the learning information. In this way, electric power stored in the storage battery 33 in the late-night charge time zone, in which the electricity cost is cheaper than that in other time zones, can be utilized to secure efficient electric power discharge. Therefore, the electric power supply system 100 is enabled to implement proper electric power discharge in a condition where electric consumption cannot be predicted from the previous electric power consumption result.

### Third Embodiment

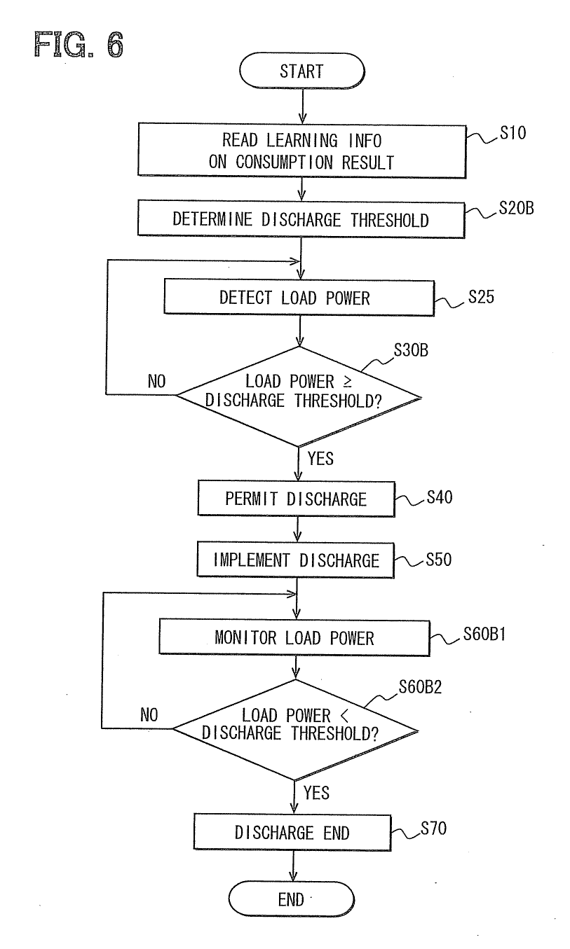

In the present third embodiment, another example of the “electric power discharge control processing of the storage battery” described in the first embodiment and the second embodiment will be described with reference to FIG. 6. FIG. 6 is a flowchart showing the electric power discharge control processing of the storage battery according to the third embodiment. The configuration, the operation, the control, the processing denoted by the same step reference numeral, etc. without specific notation in the present embodiment are deemed to be equivalent to those in the first embodiment and the second embodiment and are deemed to produce an equivalent operation effect.

As shown in FIG. 6, the “electric power discharge control processing of the storage battery” according to the present embodiment is different from the processing shown in FIG. 4 of the first embodiment in step S20B, step S25, step S30B, step S60B1, and step S60B2. The processing at step S60B1 is the same as the processing at step S60A1 in FIG. 5 of the second embodiment.

As follows, differences from the first embodiment will be described. Referring to FIG. 6, subsequent to step S10, the system ECU 31 determines the discharge threshold based on the learning information (step S20B). At step S20B, the system ECU 31 first determines the predicted electric power consumption distribution in each time zone in the present day (today) according to the learning information being read. The system ECU 31 calculates the discharge threshold for determining whether to implement the electric power discharge with respect to the predicted electric power consumption distribution in each time zone with the determination criterion to secure the electric power discharge efficiency of the storage battery 33 higher than or equal to the predetermined efficiency and to use up accumulation of electric power in the storage battery 33 effectively. The discharge threshold is determined such that the determination criterion is satisfied by implementing the electric power discharge from the storage battery 33 when the predicted electric power consumption calculated from the learning information is greater than or equal to the discharge threshold. In addition, the discharge threshold is determined such that the determination criterion is satisfied by not implementing the electric power discharge from the storage battery 33 when the predicted electric power consumption is less than the discharge threshold.

Subsequently, at step S25, when the load devices demand electric power supply, the system ECU 31 detects the load electric power of the load devices. Subsequently, at step S30B, the system ECU 31 determines whether the load electric power, which is demanded from the load devices and determined at step S20B, is greater than or equal to the discharge threshold. When the load electric power of the load devices is less than the discharge threshold, the processing returns to step S25. Alternatively, when the system ECU 31 determines that the load electric power of the load devices is greater than the discharge threshold, the system ECU 31 executes step S40 and step S50 in order thereby to implement the electric power discharge from the storage battery 33 to the load devices. Subsequent to the “electric power discharge implementation of the storage battery” at step S50, at step S60B1, the system ECU 31 detects and monitors the actual load electric power demanded from the load devices, similarly to the processing at step S60A1 of the second embodiment.

At step S60B2, the system ECU 31 determines whether the actual load electric power decreases to be less than or equal to the discharge threshold during the electric power discharge. The “electric power discharge from the storage battery” and the “monitoring of the actual load electric power” are continued until the system ECU 31 determines that the actual load electric power decreases to be less than the discharge threshold at step S60B2. On determination that the actual load electric power decreases to be less than the discharge threshold at step S60B2, the system ECU 31 terminates the electric power discharge from the storage battery 33 at step S70 and terminates the “electric power discharge control processing of the storage battery.”

As follows, an operation effect of the electric power supply system 100 according to the present embodiment will be described. The electric power supply system 100 stores the electric power consumption result consumed by the load devices, rewrites the previous electric power consumption result to update the electric power consumption result as the learning information, and controls the electric power discharge from the storage battery 33 to the load device with reference to the learning information. The electric power supply system 100 calculates the predicted electric power consumption of the load devices in each time zone in one day with reference to the learning information obtained from the electric power consumption result. The electric power supply system 100 further determines the discharge threshold as the condition for determining whether to implement the electric power discharge, according to the predicted electric power consumption in each time zone. The electric power supply system 100 implements the electric power discharge from the storage battery 33 when the load electric power of the load devices in one day is greater than the discharge threshold being determined.

With the present control, the predicted electric power consumption of the load devices in each time zone is calculated with reference to the learning information obtained from the electric power consumption result. Therefore, the predicted electric power consumption conforms to actual use of a user. The discharge threshold functions as a trigger for implementing the electric power discharge from the storage battery 33 to the load devices. The discharge threshold is determined according to the predicted electric power consumption, which conforms to actual use of a user. Accordingly, the configuration of the present embodiment enables the electric power discharge control suitable for a user. Thus, the electric power supply system 100 enables the electric power discharge suitable for the user's electric power consumption result and effective use of energy when the electric power discharge is implemented from the storage battery 33 to the load devices.

During the electric power discharge from the storage battery 33, an electric device such as a circuit board consumes certain electric power. When the load electric power is not necessarily large during the electric power discharge, the circuit board or the like consumes a large amount of electric power relative to the electric power supply from the storage battery 33. In such a case, the electric power discharge efficiency of the storage battery 33 decreases. In the present embodiment, the discharge threshold is determined with the decision criterion to secure the electric power discharge efficiency of the storage battery 33 higher than or equal to the predetermined efficiency and to use up accumulation of electric power in the storage battery 33 effectively. Therefore, the present control enables desirable electric power discharge to utilize energy effectively.

### Fourth Embodiment

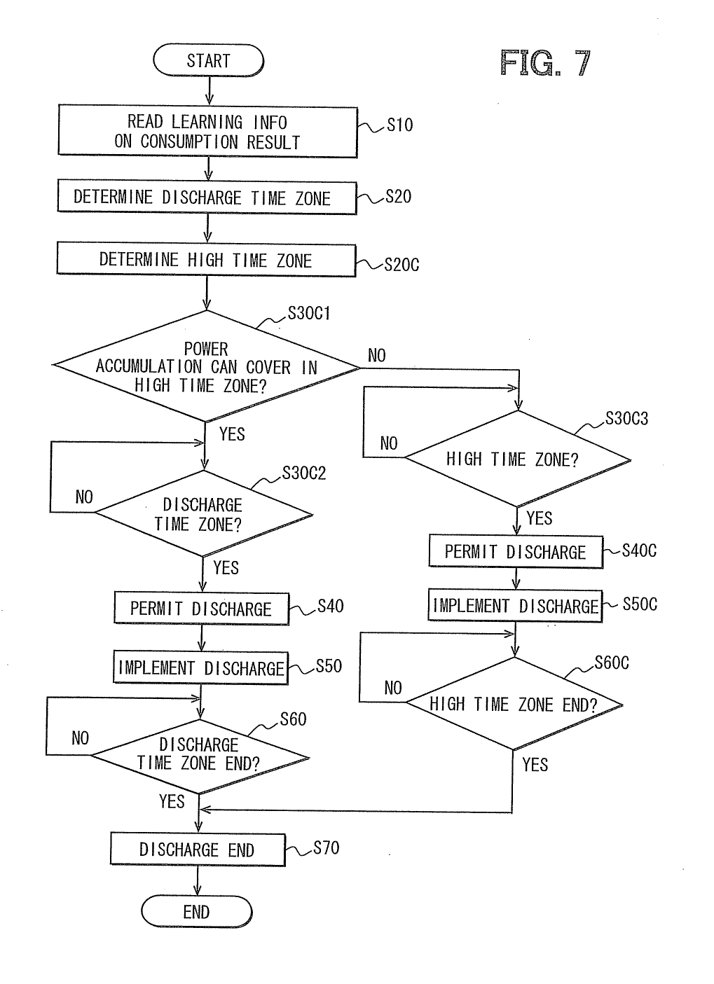

In the present fourth embodiment, another example of the “electric power discharge control processing of the storage battery” described in the first embodiment will be described with reference to FIG. 7. FIG. 7 is a flowchart showing the electric power discharge control processing of the storage battery according to the fourth embodiment. The configuration, the operation, the control, the processing denoted by the same step reference numeral, etc. without specific notation in the present embodiment are deemed to be equivalent to those in the first embodiment and are deemed to produce an equivalent operation effect.

As shown in FIG. 7, the “electric power discharge control processing of the storage battery” according to the present embodiment is different from the processing shown in FIG. 4 of the first embodiment in step S20C and step S30C1. At step S20C, the system ECU 31 determines a high electric power consumption time zone in one day with reference to the learning information obtained from the electric power consumption result stored in the storage unit 171. In the high electric power consumption time zone, the load electric power consumed by the load devices is predicted to concentrate in one day. At step S30C1, the system ECU 31 determines whether accumulation of electric power in the storage battery 33 can cover the load electric power demanded in the high electric power consumption time zone, in addition to the load electric power demanded in time zones other than the high electric power consumption time zone. When the system ECU 31 determines that accumulation of electric power in the storage battery 33 cannot cover the load electric power, the system ECU 31 implement the electric power discharge from the storage battery 33 in the high electric power consumption time zone.

The electric power discharge control of the storage battery according to the fourth embodiment prioritizes the electric power discharge from the storage battery 33 in, for example, the high electric power consumption time zone, in which the predicted electric power consumption of the load devices concentrates among time zones other than the late-night charge time zone. In addition, the electric power discharge control is implemented, such that accumulation of electric power in the storage battery 33 does not become insufficient.

As follows, differences from the first embodiment will be described. Referring to FIG. 7, subsequent to step S20, the system ECU 31 determines the high electric power consumption time zone based on the learning information (step S20C). At step S20C, the system ECU 31 determines the predicted electric power consumption distribution in the time zones, in which the electric power discharge from the storage battery 33 is enabled in one day, with reference to the learning information The system ECU 31 selects a time zone, in which electric power consumption is remarkably higher than that in the other time zones, from the predicted electric power consumption distribution. The electric power supply from the storage battery 33 in the selected time zone is the most important in one day. The system ECU 31 further determines the electric power supply as an electric power discharge operation in the high electric power consumption time zone. As described above, the high electric power consumption time zone is, for example, from the evening about 5:00 p.m. to the nighttime. In the high electric power consumption time zone, electric power consumption significantly increases due to increase in use of the electric appliances by a child after coming back home and due to increase in electric consumption for hot-water supply in order to prepare supper and bath. In addition, the state of high electric power consumption continues for a relatively long time in the high electric power consumption time zone.

Subsequently, at step S30C1, the system ECU 31 determines whether current accumulation of electric power in the storage battery 33 can cover the predicted electric power consumption in time zones other than the high electric power consumption time zone. The system ECU 31 further determines whether current accumulation of electric power in the storage battery 33 can also cover the predicted electric power consumption in the high electric power consumption time zone. On determination that current accumulation of electric power in the storage battery 33 can cover the predicted electric power consumption at step S30C1, at step S30C2, the system ECU 31 determines whether the present time transits into the discharge implementation time zone determined at step S20. On determination that the present time transits into the discharge implementation time zone, the system ECU 31 executes the processings at step S40, at step S50, at step S60, and at step S70 in order. Subsequently, the system ECU 31 terminates the electric power discharge from the storage battery 33 and terminates the “electric power discharge control processing of the storage battery.”

When the system ECU 31 determines that current accumulation of electric power in the storage battery 33 cannot cover the predicted electric power consumption at step S30C1, the accumulation of electric power in the storage battery 33 may not be supplied to all the load devices in the high electric power consumption time zone. Accordingly, it is conceivable to avoid the present state. In consideration of this, the system ECU 31 implements a discharge control to supply electric power from accumulation of electric power of the storage battery 33 with priority in the high electric power consumption time zone.

At step S30C3, the system ECU 31 determines whether the present time transits into the high electric power consumption time zone determined previously at step S20C. On determination that the present time transits into the high electric power consumption time zone at step S30C3, at step S40C, the system ECU 31 causes the charge-and-discharge permission unit 311 to instruct discharge permission to the charge-and-discharge execution unit 321. Thus, at step S50C, the charge-and-discharge execution unit 321 implements the electric power discharge of the storage battery 33.

The electric power discharge of the storage battery 33 is continued until the system ECU 31 determines that the high electric power consumption time zone ends at step S60C. On determination that the high electric power consumption time zone ends at step S60C, the system ECU 31 terminates the electric power discharge from the storage battery 33 at step S70 and terminates the “electric power discharge control processing of the storage battery.”

As follows, an operation effect of the electric power supply system 100 according to the present embodiment will be described. The electric power supply system 100 determines the high electric power consumption time zone, in which consumption of electric power by the load devices is predicted to concentrate in one day, with reference to the learning information related to the electric power consumption result (step S20C). Furthermore, on determination that accumulation of electric power in the electric power accumulating device cannot cover both the load electric power, which is predicted to be consumed in time zones other than the high electric power consumption time zone, and the load electric power, which is predicted to be consumed in the high electric power consumption time zone, the electric power supply system 100 gives priority to the electric power discharge from the electric power accumulating device in the high electric power consumption time zone (step S30C1, step S30C3, step S50C).

In the present control, the high electric power consumption time zone, in which the load electric power concentrates compared with the load electric power in the other time zones, is recognized as the most important time zone from a viewpoint of actual demand of electric power by a user. The storage battery is charged with the grid power in the late-night charge time zone at low cost, under the electric power supply contract. Accumulation of electric power in the storage battery charged with the grid power in this way is distributed in the high electric power consumption time zone with high demand prior to electric supply in other time zones. With the present configuration, the accumulation of electric power in the storage battery can be utilized effectively in the high demand time zone and can be supplied in consideration of reduction in surplus accumulation of electric power in the storage battery. Therefore, user's convenience can be enhanced, and effective use of electric power can be promoted from a viewpoint of energy saving. In addition, the high electric power consumption time zone with high demand is determined with reference to the learning information. Therefore, the high electric power consumption time zone can be extracted with high accuracy, as the important electric power-demanded time zone, suitably for the actual consumption of electric power by a user.

### Other Embodiment

As described above, the embodiments of the present disclosure have been mentioned. It is noted that the present disclosure is not limited to the above embodiments. The present disclosure may be variously modified and may be in practical use in a sprit of the present disclosure.

In the above embodiments, the storage battery 33 is the fixed rechargeable battery. It is noted that, the storage battery 33 is not limited to the rechargeable battery. The storage battery 33 may be various kinds of chargeable and dischargeable electric power accumulating devices such as a capacitor.

In the above embodiments, the building 1 is a residence. It is noted that, the building 1 is not limited to a residence. The building 1 may be, for example, a store, a factory, a warehouse, and/or the like.

In the above embodiments, the natural power source (reusable energy source) utilized in the building 1 and/or the electric power storage unit 30 is sunlight energy. It is noted that, the reusable energy source is not limited to sunlight energy. The reusable energy source being utilized may be solar thermal energy, wind power energy, hydraulic power energy, etc., and the reusable energy source converted into electric power by using various power generators may be supplied into the alternating-current electric power line 7. The alternating-current electric power line 7 is connectable with various kinds of devices using the reusable energy sources and is configured to supply electric power various load devices.

In the above embodiments, the load devices may include a thermal storage device. The thermal storage device is configured to convert, for example, electric power generated from solar energy and/or the grid-power electric power into thermal energy and to accumulate the converted thermal energy. The thermal storage device includes, for example, a tank for accumulating hot water therein for supplying hot water, a heat pump equipment for boiling water and for supplying the boiled water into the tank, and a thermal storage control device for controlling various components of the thermal storage device. The thermal storage device is configured to boil water with the heat pump equipment by utilizing electric power generated from solar energy, grid power electricity, etc., and to accumulate the boiled water as a heat source in the tank.

The electric power supply system includes: an electric power accumulating device 33 configured to be charged with electric power supplied from an electric power system 2 of an electric power supply source into a building 1 under an electric power supply contract and configured to discharge electric power to a load device 14, 15 used on the side of the building 1; and a control device 31 configured to store an electric power consumption result consumed by the load device, to rewrite a previous electric power consumption result to update the electric power consumption result as learning information, and to control electric power discharge from the electric power accumulating device to the load device with reference to the learning information. The control device is further configured to calculate a predicted electric power consumption consumed by the load device in each time zone in one day with reference to the learning information obtained from the electric power consumption result. The control device is further configured to determine, according to the predicted electric power consumption in each time zone in one day, a discharge implementation time zone, in which electric power discharge is implemented from the electric power accumulating device to the load device, or a discharge threshold as determination criterion whether to implement electric power discharge. The control device is further configured to implement electric power discharge from the electric power accumulating device to the load device when determining that it (the present time) is in the discharge implementation time zone in one day or when a load electric power consumed by the load device is greater than or equal to the determined discharge threshold.

With the present configuration, the predicted electric power consumption of the load device in each time zone is calculated with reference to the learning information obtained from the electric power consumption result. Therefore, the predicted electric power consumption conforms to actual use of a user. The discharge implementation time zone and the discharge threshold, each being a determination criterion whether to implement electric power discharge from the electric power accumulating device to the load device, are determined according to the predicted electric power consumption conforming to actual use of a user. Thus, the present configuration can produce an electric power discharge control suitable for each user. Thus, the electric power supply system enables electric power discharge suitable for the user's electric power consumption result thereby to promote effective use of energy.

The control device may be further configured to obtain fluctuation in the load electric power actually consumed by the load device when implementing electric power discharge from the electric power accumulating device. In this case, the control device may be further configured to determine a discharge termination value to terminate electric power discharge according to the obtained fluctuation in the actual load electric power. In this case, the control device may be further configured to terminate electric power discharge from the electric power accumulating device when the actual load electric power of the load device becomes less than or equal to the discharge termination value.

With the present control, the condition to terminate the electric power discharge can be determined according to the actual load electric power consumed by the load device, after starting the electric power discharge from the storage battery. With the determination of the condition to terminate electric power discharge, the electric power supply system is enabled to implement electric power discharge flexibly when actual electric power consumption result is different from the predicted electric consumption obtained with reference to the learning information. Therefore, the electric power supply system is enabled to adapt to various electric consumption conditions.

The control device may be further configured to determine a high electric power consumption time zone, in which load electric power consumed by the load device is predicted to concentrate in one day, with reference to the learning information obtained from the electric power consumption result. In this case, the control device may be further configured to implement electric power discharge from the electric power accumulating device in the high electric power consumption time zone with priority when determining that accumulation of electric power in the electric power accumulating device cannot cover the load electric power predicted to be consumed in time zones other than the high electric power consumption time zone and the load electric power predicted to be consumed in the high electric power consumption time zone.

With the present configuration, the high electric power consumption time zone, in which the load electric power concentrates compared with the other time zones, is recognized as the most important time zone from a viewpoint of electric power demand. Therefore, priority can be given to the high electric power consumption time zone, and the accumulation of electric power in the storage battery can be distributed effectively in the high electric power consumption time zone, rather than other time zones. Therefore, accumulation of electric power in the storage battery charged with electric power from the grid power system can be utilized in the time zone in which high demand of electric power exists. Therefore, user's convenience and effective use of electric power can be promoted. In addition, the high electric power consumption time zone is determined with reference to the learning information. Therefore, the high electric power consumption time zone can be extracted with high accuracy, as the important electric-power-demanded time zone, suitably for the actual consumption of electric power by a user.

The numeral in the parenthesis of each unit represents a correspondence with detailed unit in the embodiments and does not limit the corresponding claimed element.

The above configurations of the embodiments can be combined as appropriate. The above processings such as calculations and determinations are not limited being executed by the system ECU 31. The control unit may have various structures including the system ECU 31 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An electric power supply system comprising:
an electric power accumulating device configured to be charged with electric power, which is supplied from an electric power system into a building under a contract, and configured to discharge electric power to a load device of the building;
a control device configured to
store an electric power consumption result of the load device,
rewrite a previous electric power consumption result to update the electric power consumption result as learning information, and
control electric power discharge from the electric power accumulating device to the load device with reference to the learning information, wherein
the control unit is further configured to
predict, with reference to the learning information, an electric power consumption consumed by the load device in each time zone in one day,
determine, according to the predicted electric power consumption in each time zone in one day, a discharge implementation time zone or a discharge threshold, and
implement electric power discharge from the electric power accumulating device to the load device,
when determining that present time is in the discharge implementation time zone in one day, or
when a load electric power consumed by the load device is greater than or equal to the determined discharge threshold.

2. The electric power supply system according to claim 1, wherein
the control unit is further configured to
obtain fluctuation in actual load electric power actually consumed by the load device when implementing electric power discharge from the electric power accumulating device,
determine, according to the obtained fluctuation in the actual load electric power, a discharge termination value, and
terminate electric power discharge from the electric power accumulating device when the actual load electric power becomes less than or equal to the discharge termination value.

3. The electric power supply system according to claim 1, wherein
the control unit is further configured to
determine, with reference to the learning information, a high electric power consumption time zone, in which the load electric power consumed by the load device is predicted to concentrate in one day, and
implement electric power discharge from the electric power accumulating device in the high electric power consumption time zone with priority, when determining that accumulation of electric power in the electric power accumulating device cannot cover
the load electric power predicted to be consumed in time zones other than the high electric power consumption time zone and
the load electric power predicted to be consumed in the high electric power consumption time zone.

4. A method for controlling electric power discharge from an electric power accumulating device, the electric power accumulating device being configured to be charged with electric power, which is supplied from an electric power system into a building under a contract, and configured to discharge electric power to a load device of the building, the method comprising:
predicting an electric power consumption consumed by the load device in each time zone in one day, with reference to an electric power consumption result of the load device being stored and updated;
determining, according to the predicted electric power consumption, a discharge implementation time zone or a discharge threshold; and
causing the electric power accumulating device to discharge electric power to the load device,
when determining that present time is in the discharge implementation time zone, or
when a load electric power consumed by the load device is greater than or equal to the determined discharge threshold.
